(19) United States
(12) Patent Application Publication
(10) Pub. No.: US 2020/0354619 A1
(43) Pub. Date: Nov. 12, 2020

(54) Thermally Conductive Elastomer Composition and Thermally Conductive Molded Article

(71) Applicant: Kitagawa Industries Co., Ltd., Inazawa-shi, Aichi (JP)

(72) Inventors: Tatsuya Uchida, Kasugai-shi, Aichi (JP); Naohiro Tachi, Kasugai-shi, Aichi (JP)

(21) Appl. No.: 16/958,590

(22) PCT Filed: Dec. 20, 2018
(86) PCT No.: PCT/JP2018/046944

§ 371 Date: Jun. 26, 2020

(30) Foreign Application Priority Data
Dec. 28, 2017 (JP) 2017-252993

(51) Int. Cl. C09K 5/14; C08L 91/00

(52) U.S. Cl. CPC C09K 5/14; C08L 2207/322; C08L 91/00

(57) ABSTRACT

A thermally conductive elastomer composition of the present technology contains 100 parts by mass of a styrene-based elastomer, from 400 to 540 parts by mass of a process oil formed of a petroleum-based hydrocarbon, from 950 to 1350 parts by mass of aluminum hydroxide having an average particle diameter from 3 μm to 20 μ, and from 70 to 80 parts by mass of expanded graphite having an average particle diameter from 3 μm to 20 μm, where a difference between the average particle diameter of the aluminum hydroxide and the average particle diameter of the expanded graphite is within 5 μm.

### TECHNICAL FIELD

The present technology relates to a thermally conductive elastomer composition and a thermally conductive molded article.

### BACKGROUND ART

On substrates for electrical and electronic devices on which heat generating electrical or electronic components (hereinafter, heat-generating components) such as power transistors, ICs (integrated circuits), and the like are mounted, heat-generating components and the like are mounted at a high density for the purpose of reducing weight. Therefore, in recent years, the amount of heat generated by this type of substrate has increased.

In the related art, as a countermeasure for this type of heat-generating component and a substrate on which the heat-generating component is mounted, for example, a thermally conductive molded article containing a thermally conductive filler along with a styrene-based elastomer as a base polymer has been used, as disclosed in Japan Unexamined Patent Publication No. 2015-193785. This type of thermally conductive molded article is used, for example, in a form interposed between a heat-generating component mounted on a substrate and a heat dissipating body such as a heat sink, and transmits heat emitted from the heat-generating component to the heat dissipating body.

When a gap is formed between the thermally conductive molded article and the heat-generating component, or between the thermally conductive molded article and the heat dissipating body, the heat dissipation efficiency decreases, and therefore, the thermally conductive molded article needs to be appropriately adhered to various heat-generating components having different mounting heights and sizes. Therefore, the thermally conductive molded article needs to have flexibility (low hardness) so as to follow the heat-generating component or the like. The thermally conductive molded article also needs to have the insulating properties from the viewpoint of ensuring a normal operation of the electronic component or the like.

Note that, in the thermally conductive molded article, the thermally conductive filler is blended in a proportion from 2000 to 6000 parts by mass with respect to 100 parts by mass of a styrene-based elastomer. In addition, expandable graphite (unexpanded graphite) is used as a part of the thermally conductive filler.

As described above, since a large amount of thermally conductive filler is blended in the conventional thermally conductive molded article, a large amount of paraffin oil is also blended in order to ensure the flexibility. As a result, oil may bleed from a surface of the conventional thermally conductive molded article. In addition, since expandable graphite has been used as a thermally conductive filler, depending on a processing temperature of the thermally conductive molded article, the expandable graphite expands, and the shape of the thermally conductive molded article may be deformed.

### SUMMARY

The present technology provides a thermally conductive elastomer composition and a thermally conductive molded article that have excellent thermal conductivity, insulating properties, low hardness, and moldability, and suppress the occurrence of oil bleeding.

As a result of conducting diligent research, the inventors of the present technology have discovered that a thermally conductive molded article formed of a thermally conductive elastomer composition including 100 parts by mass of a styrene-based elastomer, from 400 to 540 parts by mass of a process oil formed of a petroleum-based hydrocarbon, from 950 to 1350 parts by mass of aluminum hydroxide having an average particle diameter from 3 μm to 20 μm, and from 70 to 80 parts by mass of expanded graphite having an average particle diameter from 3 μm to 20 μm, which are blended with each other, where a difference between the average particle diameter of the aluminum hydroxide and the average particle diameter of the expanded graphite is within 5 μm, has excellent thermal conductivity, insulating properties, low hardness, and moldability, and suppresses occurrence of oil bleeding.

A description of the technology is as follows. That is,

<1> A thermally conductive elastomer composition containing a blend of 100 parts by mass of a styrene-based elastomer, from 400 to 540 parts by mass of a process oil formed of a petroleum-based hydrocarbon, from 950 to 1350 parts by mass of aluminum hydroxide having an average particle diameter from 3 μm to 20 μm, and from 70 to 80 parts by mass of expanded graphite having an average particle diameter from 3 μm to 20 μm, wherein a difference between the average particle diameter of the aluminum hydroxide and the average particle diameter of the expanded graphite is within 5 μm.

<2> The thermally conductive elastomer composition according to the above <1>, wherein the aluminum hydroxide is a surface-treated aluminum hydroxide that has undergone a surface treatment, and an amount of the surface-treated aluminum hydroxide is 400 parts by mass or less.

<3> The thermally conductive elastomer composition according to the above <1> or <2>, wherein an amount of the process oil is from 430 to 530 parts by mass.

<4> The thermally conductive elastomer composition according to any one of the above <1>to <3>, wherein the expanded graphite is in a state where flakes of graphite and granules and/or chunks of graphite being mixed. Note that in the present specification, “granules and/or chunks of graphite” may be only granules, only chunks, or both chunks and chunks of graphite.

<5> A thermally conductive molded article obtained by molding the thermally conductive elastomer composition according to any one of the above <1>to <4>.

According to the technology of the present application, provided is a thermally conductive elastomer composition and a thermally conductive molded article that have excellent thermal conductivity, insulating properties, low hardness, and moldability, and suppress the occurrence of oil bleeding.

Other characteristics and advantages of the present technology will become apparent from the following description with reference to the accompanying drawings. Note that, in the accompanying drawings, the same reference numerals are assigned to the same or similar configurations.

### BRIEF DESCRIPTION OF DRAWINGS

The accompanying drawings are included in the specification, constitute a part thereof, and illustrate embodiments of the present technology, and together with the description, the drawings are used to explain the principles of the present technology.

FIG. 1 is a SEM (Scanning Electron Microscope) image of expandable graphite observed at 500 times.

FIG. 2 is an explanation diagram schematically illustrating a configuration of a thermally conductive elastomer composition according to the present embodiment.

FIG. 3 is an explanation diagram schematically illustrating a configuration of a thermally conductive elastomer composition according to Comparative Example X.

FIG. 4 is an explanation diagram schematically illustrating a configuration of a thermally conductive elastomer composition according to Comparative Example Y.

FIG. 5 is a side view schematically illustrating an example of a thermally conductive molded article.

FIG. 6 is a cross-sectional view schematically illustrating a state in which the thermally conductive molded article is mounted on a heat dissipation target.

### DETAILED DESCRIPTION

### Thermally Conductive Elastomer Composition

The thermally conductive elastomer composition of the present embodiment contains expanded graphite together with aluminum hydroxide as a thermally conductive filler. In particular, a particle diameter of the aluminum hydroxide and a particle diameter of the expanded graphite are set to the same degree as described below. Furthermore, aside from the thermally conductive filler, the thermally conductive elastomer mainly has a styrene-based elastomer, a process oil consisting of petroleum-based hydrocarbon, and the like.

### Styrene-based Elastomer

A styrene-based elastomer is a base polymer of a thermally conductive elastomer composition, and is preferably provided with thermal plasticity and appropriate elasticity. Examples of the styrene-based elastomer include a hydrogenated styrene-isoprene-butadiene block copolymer (SEEPS), a styrene-isoprene-styrene block copolymer (SIS), a styrene-isobutylene copolymer (SIBS), a styrene-butadiene-styrene block copolymer (SBS), a styrene-ethylene-propylene block copolymer (SEP), a styrene-ethylene-butylene-styrene block copolymer (SEBS), a styrene-ethylene-propylene-styrene block copolymer (SEPS). These may be used alone or in a combination of two or more.

The styrene-based elastomer is preferably obtained by hydrogenating a block copolymer formed of a polymer block A containing at least two vinyl aromatic compounds as a main constituent and a polymer block B containing at least one type of conjugated diene compound.

Examples of the vinyl aromatic compound include styrene, α-methylstyrene, o-methylstyrene, m-methylstyrene, p-methylstyrene, 1,3-dimethylstyrene, vinylnaphthalene, and vinyl anthracene. Among these, styrene and α-methylstyrene are preferable. One type of aromatic vinyl compound may be used alone, or two or more types thereof may be used in combination.

The content of the vinyl aromatic compound in the styrene-based elastomer is preferably from 5% to 75% by mass, and more preferably from 5% to 50% by mass. When the content of the vinyl aromatic compound is within this range, elasticity of the thermally conductive elastomer composition is easily ensured.

Examples of the conjugated diene compound include butadiene, isoprene, 2,3-dimethyl-1,3-butadiene, 1,3-pentadiene, and 1,3-hexadiene. One type of conjugated diene compound may be used alone, or two or more types thereof may be used in combination. Among these, the conjugated diene compound is preferably at least one selected from isoprene and butadiene, and more preferably a mixture of isoprene and butadiene.

In the styrene-based elastomer, a carbon-carbon double bond derived from the conjugated diene compound of the polymer block B is preferably hydrogenated by 50% or greater, more preferably hydrogenated by 75% or greater, and particularly preferably hydrogenated by 95% or greater.

The styrene-based elastomer may contain at least one polymer block A and at least one polymer block B, and from the viewpoint of heat resistance, mechanical properties, or the like, it is preferable to contain two or more polymer blocks A and one or more polymer blocks B. A bond style of the polymer block A and the polymer block B may be linear, branched, or any combination thereof; however, when the polymer block A is represented by A and the polymer block B is represented by B, a triblock structure represented by A-B-A and a multiblock copolymer represented by (A-B)n and (A-B)n-A (here, n represents an integer of 2 or more) can be exemplified, and among them, those having a triblock structure represented by A-B-A are particularly preferable in terms of heat resistance, mechanical properties, handleability, and the like.

A weight average molecular weight of the styrene-based elastomer is preferably, from 80000 to 400000, and more preferably, from 100000 to 350000. Note that the weight average molecular weight herein is a weight average molecular weight in terms of standard polystyrene measured by gel permeation chromatography (GPC). The measurement conditions of the weight average molecular weight are as follows.

### Measurement Conditions

GPC: LC Solution (available from SHIMADU)

Detector: Differential refractometer RID-10A (available from SHIMADU)

Column: TSK gel G4000Hx1 in two series (available from Tosoh)

Guard column: TSK guard column Hx1-L (available from Tosoh)

Solvent: Tetrahydrofuran

Temperature: 40° C.

Flow rate: 1 ml/min

Concentration: 2 mg/ml

The styrene-based elastomer is particularly preferably SEEPS. As a commercially available product of SEEPS, for example, SEPTON (trade name) 4033, 4404, 4055, 4077, and 4099 available from Kuraray Co., Ltd. can be used. Among these, from the perspective of miscibility, moldability, and the like with other materials, SEPTON (trade name) 4055 (weight average molecular weight: 270000) is particularly preferable.

### Process Oil

The process oil is provided with a function of softening a styrene-based elastomer (for example, SEEPS), and is formed of petroleum-based hydrocarbon. The petroleum-based hydrocarbon is not particularly limited as long as the present technology is not impaired, and for example, a paraffin-based hydrocarbon compound is preferable. That is, the process oil is preferably a paraffin-based process oil. The paraffin-based process oil preferably has a molecular weight from 500 to 800. Specific examples of the paraffin-based process oil include “Diana Process Oil PW-380 (molecular weight: 750)” (available from Idemitsu Kosan Co., Ltd.).

In the thermally conductive elastomer composition, the amount of the process oil with respect to 100 parts by mass of the styrene-based elastomer is, from 400 to 540 parts by mass, preferably from 430 to 530 parts by mass, and more preferably from 460 to 520 parts by mass.

### Aluminum Hydroxide

Aluminum hydroxide is powdered and is used to impart characteristics such as thermal conductivity and flame retardancy like to the thermally conductive elastomer composition. An average particle diameter of the aluminum hydroxide is from 3 μm to 20 μm, and preferably from 5 μm to 15 μm. When the average particle diameter of the aluminum hydroxide is within this range, the appearance (blooming) of a filler, such as aluminum hydroxide, from the surface of the molded article is suppressed. The shape of the aluminum hydroxide is not particularly limited as long as the present technology is not impaired, and for example, a generally available granular (generally spherical) shape may be used.

The average particle diameter of the aluminum hydroxide is an average particle diameter (D50) based on volume according to a laser diffraction method. The average particle diameter can be measured with a laser diffraction particle diameter distribution meter. Note that the average particle diameter of the expanded graphite or the like described below is also the average particle diameter (D50) based on the volume according to the laser diffraction method.

A coupling agent (for example, a titanate coupling agent) or a surface-treated aluminum hydroxide that has undergone a surface treatment with stearic acid may be used as a part of the aluminum hydroxide. For example, when the surface-treated aluminum hydroxide that has undergone a surface treatment with a titanate coupling agent is used, the flexibility of the thermally conductive elastomer composition and the molded article thereof is improved, and hardness is not easily increased. Furthermore, when surface-treated aluminum hydroxide that has undergone a surface treatment with stearic acid is used, the dispersibility and the like of the thermally conductive elastomer composition and the molded article thereof are improved.

Note that in order to distinguish from the surface-treated aluminum hydroxide, aluminum hydroxide which has not undergone a surface treatment may be referred to as “surface-untreated aluminum hydroxide”. As the aluminum hydroxide, the surface-untreated aluminum hydroxide is essentially used.

In the thermally conductive elastomer composition, the amount of the aluminum hydroxide (a total of an amount of the surface-untreated aluminum hydroxide and an amount of the surface-treated aluminum hydroxide blended) with respect to 100 parts by mass of the styrene-based elastomer is from 950 parts by mass to 1350 parts by mass, and preferably from 1050 parts by mass to 1250 parts by mass.

Although the use of surface-treated aluminum hydroxide is not essential in the thermally conductive elastomer composition, when the surface-treated aluminum hydroxide is used, the amount thereof is preferably 400 parts by mass or less, more preferably 250 parts by mass or less, and still more preferably 200 parts by mass or less, with respect to 100 parts by mass of the styrene-based elastomer.

When the surface-untreated aluminum hydroxide is used in combination with the surface-treated aluminum hydroxide as the aluminum hydroxide, the average particle diameter thereof is set to be within the ranges described above.

In a step of producing the thermally conductive elastomer composition, when the aluminum hydroxide and the process oil are mixed, the mixture may become clay-like or ball-like. In a case where the mixture becomes clay-like or ball-like, bridging may occur in a feeder or at an inlet of a twin screw extruder upon material feeding when the mixture is processed into pellets. Therefore, DOP (dioctylphthalate) oil absorption (DOP oil absorption when the surface-untreated aluminum hydroxide is mixed with the surface-treated aluminum hydroxide) is preferably 27 (mL/100 g) or greater, and more preferably 32 (mL/100 g) or greater. When the DOP oil absorption of aluminum hydroxide is at such a value, mixing with the process oil does not result in a clay-like or dump-like mixture, resulting in a powdery mixture.

Note that the DOP oil absorption of the aluminum hydroxide tends to be smaller as the particle diameter is large and tends to be larger as the particle diameter is small. Therefore, from the viewpoint of the DOP oil absorption of the aluminum hydroxide, the particle diameter of the aluminum hydroxide is preferably small. In addition, from the viewpoint of the oil bleeding, the particle diameter of the aluminum hydroxide is preferably small, and the larger the particle diameter of the aluminum hydroxide, the more the amount of oil bleeding of the thermally conductive elastomer composition (thermally conductive molded article).

### (Expanded Graphite)

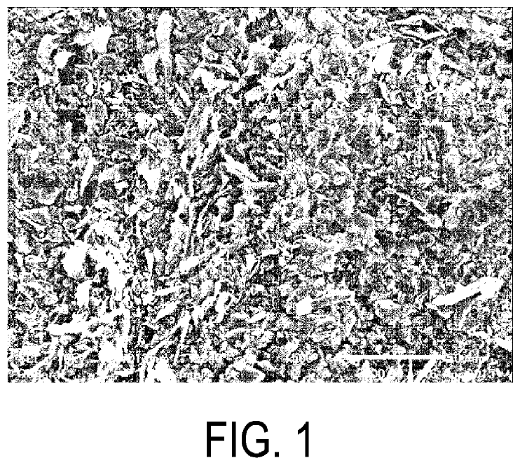

Expanded graphite (expandable graphite) is utilized as a thermally conductive filler together with aluminum hydroxide. The expanded graphite is obtained by expanding the expandable graphite by heating, and then pulverizing a sheet obtained by pressing. Note that the expandable graphite is formed of flakes of graphite that has been acid-treated with sulfuric acid or the like, and sulfuric acid or the like is inserted between the layers. In the expanded graphite, a graphite layer (graphene layer) becomes thinner than the flakes of graphite, and the thermal conductivity can be increased with a small additional amount of the expanded graphite by being used as a filler. Furthermore, the expanded graphite is easily mixed with a resin component as compared to the flakes of graphite, and therefore, the thermally conductive filler blended with the styrene-based elastomer can be said to be superior to the scaly graphite. FIG. 1 is a SEM image of expandable graphite observed at 500 times. The expandable graphite of FIG. 1 is under the product name “E1500” (available from Nishimura Graphite Co., Ltd., average particle diameter of 10 μm). As illustrated in FIG. 1, the flakes of graphite remain in an uncompressed area when pressed as described above, and the granules or chunks of graphite is present in a compressed area. As a result, the expanded graphite is in a mixed state in which flakes of graphite and small granules or chunks of graphite are entangled.

The expanded graphite is formed by pressing the expandable graphite after expansion, and thus is layered, and it is easy to impregnate the process oil and contributes to suppressing oil bleeding.

In the thermally conductive elastomer composition, the amount of the expanded graphite blended relative to 100 parts by mass of the styrene-based elastomer is from 70 parts by mass to 80 parts by mass.

The average particle diameter of the expanded graphite is from 3 μm to 20 μm and preferably from 5 μm to 15 μm. However, the difference between the average particle diameter of the aluminum hydroxide and the average particle diameter of the expanded graphite is within 5 μm, preferably within 3 μm, and more preferably within 1 μm. In other words, in the present embodiment, the particle diameter (average particle diameter) of the aluminum hydroxide and the particle diameter (average particle diameter) of the expanded graphite are set to the same degree.

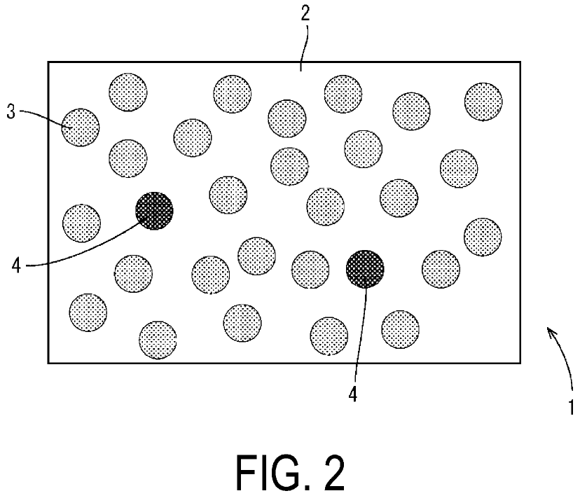

FIG. 2 is an explanation diagram schematically illustrating a configuration of a thermally conductive elastomer composition 1 according to the present embodiment. Reference sign 2 in FIG. 2 is a matrix (base material) formed of a styrene-based elastomer, a process oil, or the like, and aluminum hydroxide 3 having a similar particle diameter and expanded graphite 4 are present in the matrix 2. Furthermore, in the matrix 2, the thermally conductive filler formed of the aluminum hydroxide 3 and the expanded graphite 4 is disposed so as to be evenly spaced from each other.

In this way, by aligning the particle diameters (average particle diameters) of the aluminum hydroxide and the expandable graphite to the same degree, a substantially uniform gap is formed between the dispersed thermally conductive fillers (aluminum hydroxide and expanded graphite) in the matrix 2 of the thermally conductive elastomer composition 1, and therefore, it is presumed that a resin component such as a styrene-based elastomer or a process oil (matrix 2) is unlikely to move, and suppression of the oil bleeding and the insulating properties (high volume resistivity and high withstand voltage) are ensured.

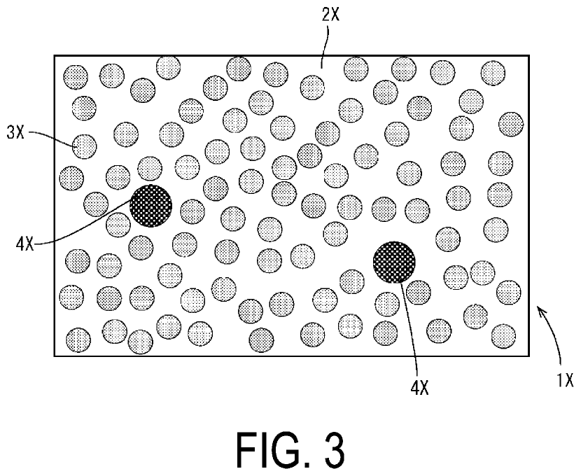

FIG. 3 is an explanation diagram schematically illustrating a configuration of a thermally conductive elastomer composition 1X according to Comparative Example X. In Comparative Example X, a particle diameter (average particle diameter) of aluminum hydroxide 3X is smaller than a particle diameter (average particle diameter) of expanded graphite 4X, and a difference in the particle diameter thereof is greater than 5 μm. Reference sign 2X in FIG. 3 is a matrix (base material) formed of a styrene-based elastomer or the like, and there is the expanded graphite 4X having a particle diameter similar to that of the expanded graphite 4 of the present embodiment and the aluminum hydroxide 3X having a particle diameter smaller than that of the expanded graphite 4X in the matrix 2X. Note that the amount (mass) of the aluminum hydroxide 3X and the expanded graphite 4X is the same as the amount (mass) of the aluminum hydroxide 3 and the expanded graphite 4 of the present embodiment. Thus, when the aluminum hydroxide 3X having the particle diameter smaller than that of the expanded graphite 4X is used, a gap, which is smaller than that of the present embodiment, is formed between the dispersed thermally conductive fillers (aluminum hydroxide 3X and expanded graphite 4X), and therefore, it is presumed that a resin component such as a styrene-based elastomer or a process oil (matrix 2X) is unlikely to move, and suppression of the oil bleeding and the insulating properties (high volume resistivity and high resistance resistance) are ensured. However, when the aluminum hydroxide 3X having a small particle diameter is added at the same blending ratio as that of the aluminum hydroxide 3 of the present embodiment, the hardness of the thermally conductive elastomer composition 1X is excessively high, and resilience (compression set) becomes considerably worse.

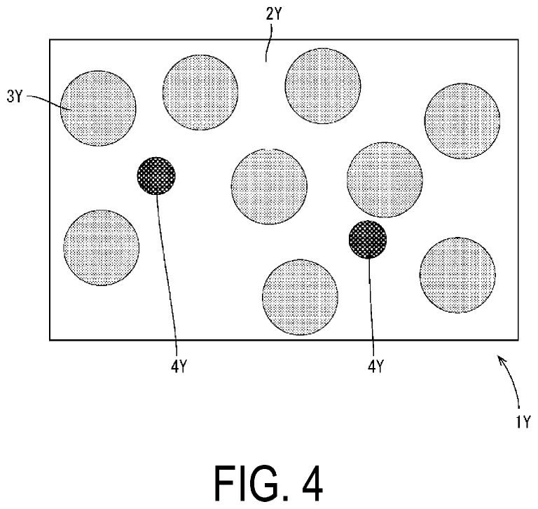

FIG. 4 is an explanation diagram schematically illustrating a configuration of a thermally conductive elastomer composition 1Y according to Comparative Example Y. In Comparative Example Y, a particle diameter (average particle diameter) of aluminum hydroxide 3Y is larger than a particle diameter (average particle diameter) of expanded graphite 4Y, and a difference in the particle diameter thereof is greater than 5 μm. Reference sign 2Y in FIG. 4 is a matrix (base material) formed of a styrene-based elastomer or the like, and there is the expanded graphite 4Y having a particle diameter similar to that of the expanded graphite 4 of the present embodiment and the aluminum hydroxide 3Y having a particle diameter larger than that of the expanded graphite 4Y in the matrix 2Y. Note that the amount (mass) of the aluminum hydroxide 3Y and the expanded graphite 4Y is the same as the amount (mass) of the aluminum hydroxide 3 and the expanded graphite 4 of the present embodiment. Thus, when the aluminum hydroxide 3Y having the particle diameter larger than that of the expanded graphite 4Y is used, a gap, which is larger than that of the present embodiment, is formed between the dispersed thermally conductive fillers (aluminum hydroxide 3Y and expanded graphite 4Y), and therefore, it is presumed that a resin component such as a styrene-based elastomer or a process oil (matrix 2Y) is easily moved and low hardness is ensured; however, problems such as the occurrence of oil bleeding and a reduction in the insulating properties still remain.

### Other Additives

The thermally conductive elastomer composition may further include a release agent, a metal deactivator and an antioxidant.

The release agent is not particularly limited as long as the present technology is not impaired, and for example, an aliphatic ester-type nonionic surfactant such as sorbitan monostearate is used. In the thermally conductive elastomer composition, the amount of the release agent is preferably from 30 to 40 parts by mass with respect to 100 parts by mass of the styrene-based elastomer.

The metal deactivator is not particularly limited as long as the present technology is not impaired, and for example, N′1,N′12-bis(2-hydroxybenzoyl) dodecane hydrazide is used. In the thermally conductive elastomer composition, the amount of the metal deactivator is preferably from 4 to 6 parts by mass with respect to 100 parts by mass of the styrene-based elastomer.

The antioxidant is not particularly limited as long as the present technology is not impaired, and for example, a hindered phenol-based antioxidant, and an amine-based antioxidant are used. In the thermally conductive elastomer composition, the amount of the antioxidant is preferably from 4 to 6 parts by mass with respect to 100 parts by mass of the styrene-based elastomer.

As long as the present technology is not impaired, the thermally conductive elastomer composition may further contain an ultraviolet light blocking agent, a coloring agent (pigment or dye), a thickening agent, a filler, a thermoplastic resin, a surfactant, and the like.

The thermally conductive elastomer composition described above has excellent thermal conductivity, insulating properties, low hardness, and moldability, and suppresses the occurrence of oil bleeding. In addition, similarly, the thermally conductive molded article obtained from the thermally conductive elastomer composition has excellent thermal conductivity, insulating properties, low hardness, and moldability, and suppresses the occurrence of oil bleeding.

The hardness of the thermally conductive elastomer composition (Asker C) is preferably from 19 to 31, more preferably from 20 to 30, and still more preferably from 22 to 25. When the hardness (Asker C) is within this range, undesired load is prevented from being applied to the target (for example, the substrate) of the heat countermeasure. The thermally conductive elastomer composition also has a function of absorbing vibration, shock, or the like to protect the target.

The thermal conductivity of the thermally conductive elastomer composition is preferably 0.96 W/m⋅K or higher, and more preferably 1.00 W/m⋅K or higher. The upper limit of the thermal conductivity is not particularly limited, and is, for example, 1.5 W/m⋅K. In a case where the thermally conductive elastomer composition of the present embodiment is processed into a sheet shape, the thermal conductivity is enhanced not only in the planar direction but also in the thickness direction. It is presumed that the reason for this is that by using expanded graphite in which flakes of graphite and granules of graphite are mixed as the thermally conductive filler, it is easy to form a passage (path) of heat due to the heat conductive filler not only in the planar direction but also in the thickness direction.

The volume resistivity of the thermally conductive elastomer composition is preferably 1×10¹³Ω⋅cm or greater and more preferably 1×10¹⁴Ωωcm or greater.

A withstand voltage of the thermally conductive elastomer composition is preferably 6 kV or greater.

The specific gravity of the thermally conductive elastomer composition is preferably from 1.40 to 1.70 g/cm³, more preferably from 1.40 to 1.60 g/cm³, and still more preferably from 1.40 to 1.50 g/cm³.

### Thermally Conductive Molded Article

The thermally conductive molded article is formed by molding the thermally conductive elastomer composition into a predetermined shape. A method of molding the thermally conductive molded article is not particularly limited as long as it is a general molding method for a thermoplastic elastomer (for example, a styrene-based elastomer), and examples thereof include injection molding and sheet molding using a press or T die.

The thermally conductive molded article is used, for example, as a member (thermally conductive member) for releasing heat emitted from electronic components or the like in the electronic device to the outside. The thermally conductive molded article is used for the purpose of the heat countermeasure, protection, or the like of a substrate in the electronic device or the like.

Examples of the electronic devices in which the thermally conductive molded article is used include mobile devices such as smartphones, portable gaming devices, portable televisions, tablet terminals, and other devices other than portable devices.

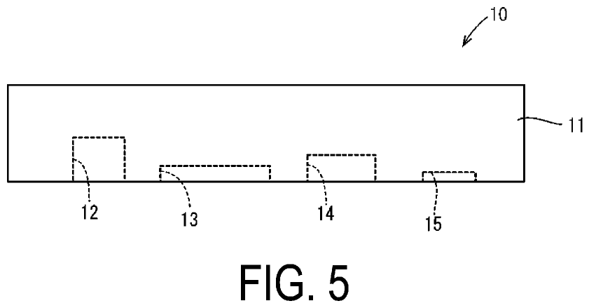

FIG. 5 is a side view schematically illustrating an example of a thermally conductive molded article 10. The thermally conductive molded article 10 is formed of a thermally conductive elastomer composition as a material and molded by using a predetermined mold. The thermally conductive molded article 10 generally includes a generally flat cuboid body 11 and a plurality of accommodating units 12, 13, 14, and 15 recessed on the back surface side. Each of the accommodating units 12, 13, 14, and 15 is formed in accordance with the shape of the heat dissipation target.

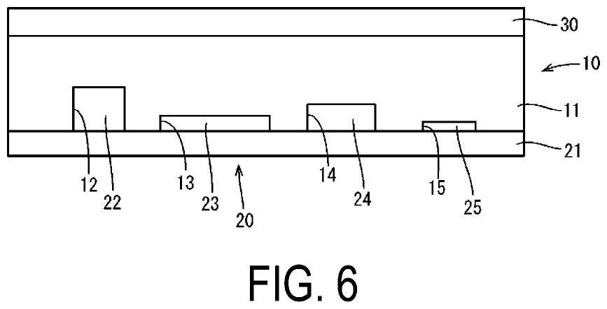

FIG. 6 is a cross-sectional view schematically illustrating a state in which the thermally conductive molded article 10 is mounted on a heat dissipation target 20. The thermally conductive molded article 10 is mounted in a state of being mounted on a substrate device that is a heat dissipation target 20. The substrate device includes a substrate 21 and a plurality of electronic components 22, 23, 24, and 25 mounted on the substrate 21. Each of the accommodating units 12, 13, 14, and 15 of the thermally conductive molded article 10 is covered in a state of being adhered to the electronic components (heat-generating components) 22, 23, 24, and 25 on the substrate 21. Note that a metal heat sink 30 is mounted on the front side of the thermally conductive molded article 10. The heat generated from each of the electronic components 22 and the like of the heat dissipation target 20 moves to the thermally conductive molded article 10 and moves further to the heat sink 30, thereby cooling the electronic components 22 and the like of the heat dissipation target 20.

As described above, the thermally conductive molded article is provided with a shape corresponding to the shape of the heat dissipation target, and it is possible to reliably adhere to the heat dissipation target to perform heat countermeasure, protection, or the like.

The shape of the thermally conductive molded article may be appropriately set depending on the purpose, and may be, for example, a sheet shape.

### EXAMPLES

The present technology will be described below in more detail based on examples. The present technology is not limited to these examples.

### Examples 1 to 8 and Comparative Examples 1 to 8

### Production of Composition

A process oil, a release agent, a metal deactivator, an antioxidant, aluminum hydroxide, and graphite were blended in the proportions (parts by mass) indicated in Tables 1 and 2 with respect to 100 parts by mass of a styrene-based elastomer, and the mixture was kneaded under the conditions of 100 rpm and 200° C. for 7 minutes by using LABO PLASTOMILL (twin screw extruder, product name “4C150-1”, available from Toyo Seiki Seisaku-sho, Ltd.), thereby obtaining compositions of Example 1 to 8. Each composition was cooled to 100° C. or lower, and then removed from the LABO PLASTOMILL to be used in the next step described below (production of the molded article).

Note that the components (materials) used in each of the examples are as follows.

“Styrene-based elastomer”: SEEPS (hydrogenated styrene-isoprene-butadiene-block copolymer), product name “SEPTON 4055”, available from Kuraray Co., Ltd.

“Process Oil”: Petroleum-based hydrocarbons, product name “Diana Process Oil PW-380”, available from Idemitsu Kosan Co., Ltd.

“Release agent”: Sorbitan monostearate, product name “RHEODOL SP-S10V”, available from Kao Corporation

“Metal deactivator”: N′1,N′12-bis(2-hydroxybenzoyl) dodecane hydrazide, product name “ADK STAB CDA-6”, available from ADEKA Corporation

“Antioxidant”: Pentaerythritol tetrakis[3-(3,5-di-tert-butyl-4-hydroxyphenyl) propionate] (hindered phenol-based antioxidant), product name “IRGANOX #1010”, available from BASF Japan Ltd.

“Aluminum hydroxide (1 μm)”: Average particle diameter of 1 μm, DOP oil absorption of 47 mL/100 g, BET (Brunauer-Emmett-Teller) specific surface area of 4.7 m²/g, light bulk density of 0.25 g/cm³, heavy bulk density of 0.51 g/cm³, spherical, product name “BF013”, available from Nippon Light Metal Company, Ltd.

“Aluminum hydroxide (10 μm)”: Average particle diameter of 10 μm, DOP oil absorption of 32 mL/100 g, BET specific surface area of 0.7 m²/g, light bulk density of 0.83 g/cm³, heavy bulk density of 1.23 g/cm³, spherical, product name “BF083”, available from Nippon Light Metal Company, Ltd.

“Aluminum hydroxide (27 μm)”: Average particle diameter of 27 μm, DOP oil absorption of 27 mL/100 g, BET specific surface area of 3.1 m²/g, light bulk density of 0.85 g/cm³, heavy bulk density of 1.33 g/cm³, spherical, product name “SB303”, available from Nippon Light Metal Company, Ltd.

“Aluminum hydroxide (80 μm)”: Average particle diameter of 80 μm, DOP oil absorption of 28 mL/100 g, BET specific surface area of 0.2 m²/g, light bulk density of 1.33 g/cm³, heavy bulk density of 1.51 g/cm³, spherical, product name “SB73”, available from Nippon Light Metal Company, Ltd.

“Aluminum hydroxide (105 μm)”: Average particle diameter of 105 μm, DOP oil absorption of 27 mL/100 g, BET specific surface area of 0.1 m²/g, light bulk density of 1.28 g/cm³, heavy bulk density of 1.45 g/cm³, spherical, product name “SB93”, available from Nippon Light Metal Company, Ltd.

“Surface-treated aluminum hydroxide (10 μm)”: Average particle diameter of 10 μm, DOP oil absorption of 12 mL/100 g, light bulk density of 0.80 g/cm³, heavy bulk density of 1.30 g/cm³, spherical, product name “BX053T”, available from Nippon Light Metal Company, Ltd.

“Artificial graphite (10 μm)”: Average particle diameter of 10 μm, true specific gravity of 2.2 g/cm³, bulk specific gravity 0.3 g/cm³, plate shape, product name “UF-G30”, available from Showa Denko K.K.

“Expanded graphite (10 μm)”: Average particle diameter of 10 μm, true specific gravity of 2.26 g/cm³, product name “E1500”, available from Nishimura Graphite Co., Ltd.

“Expanded graphite (75 μm)”: Average particle diameter of 75 μm, true specific gravity of 2.26 g/cm³, product name “E200”, available from Nishimura Graphite Co., Ltd.

“Expanded graphite (250 μm)”: Average particle diameter of 250 μm, true specific gravity of 2.26 g/cm³, product name “E40”, available from Nishimura Graphite Co., Ltd.

### Production of Molded Article

A mold (60 mm×60 mm) set in a 50-ton press machine (product name “hydraulic molding machine type C”, available from IWAKI INDUSTRY Co., Ltd) was heated for 1 minute at 180° C., and then each of the compositions described above was fed into the mold. Next, the mold was heated at 180° C. for 1 minute while being sandwiched by a press (pressing condition: about 2 ton), and then cooled for 2 minutes while being sandwiched by a cooling press at room temperature. Then, the sheet-shaped molded article (60 mm×60 mm×1 mm) was removed from the mold after cooling. In the same manner, the sheet-shaped molded articles with different thicknesses (60 mm×60 mm×6 mm, 60 mm×60 mm×12 mm) were also produced using the compositions. In addition, the molded articles (125 mm×13 mm×1 mm) were also produced to evaluate flame retardancy as described below. In this way, a molded article formed of the compositions of Example 1 to 8 and Comparative Example 1 to 8 was obtained.

### Evaluation

The hardness, thermal conductivity, volume resistivity, withstand voltage, specific gravity, miscibility, moldability, compression set, filler bloom, flame retardance, and oil bleeding were evaluated by methods described below for the molded articles of Example 1 to 8 and Comparative Example 1 to 8.

### Hardness

A test piece was cut from a molded article of each example into a size of 60 mm×30 mm×12 mm. In addition, a constant pressure load device for a rubber hardness meter (available from Elastron, Inc.) and an Asker C hardness meter were prepared. A pressing needle of the hardness meter was brought into contact with the test piece, the value of the hardness meter was read 30 seconds after all the loads were applied, and the value was taken as the hardness (Asker C). The results are shown in Table 1 and Table 2.

### Thermal Conductivity

Two pieces cut from the molded article of each example into a size of 30 mm×30 mm×12 mm were used as a set of test pieces. Then, a polyimide sensor was sandwiched between the set of test pieces, and the thermal conductivity (W/m⋅K) was measured by a hot disk method. Note that a hot disk thermal property measuring apparatus (product name “TPS500”, available from Hot Disk) was used for the measurement. The results are shown in Table 1 and Table 2.

### Volume Resistivity

A molded article (60 mm×60 mm×6 mm) of each example was used as a test piece. The volume resistivity (ΩΩcm) of each test piece was measured by using a measuring apparatus (product name “Hiresta-UP (MCP-HT450)”, available from Mitsubishi Chemical Corporation). Note that a probe used for the measurement was URS, the applied voltage was 1000 V, and the time (timer) was 10 seconds. The results are shown in Table 1 and Table 2.

### Withstand Voltage

A molded article (60 mm×60 mm×6 mm) of each example was used as a test piece. A withstand voltage tester (product name “TOS5101”, available from Kikusui Electronics Corporation) was prepared as a measuring apparatus. With the test piece sandwiched between a pair of electrodes, the applied voltage was gradually increased, and the short circuit was taken as the withstand voltage value. Note that a voltage range during the measurement was AC10kV, and the current was 10 mA (UPPER) and 0.1 mA (LOWER). The results are shown in Table 1 and Table 2.

### Specific Gravity

Specific gravity (g/cm³) of the molded article of each example was measured using a specific gravity measurement balance (product name “AG204”, manufactured by Mettler-Toledo International Inc.). The specific gravity calculation formula is as follows. The results are shown in Table 1 and Table 2.

Specific gravity=mass of molded article in atmosphere/(mass of molded article in atmosphere—mass of molded article in water)

### Miscibility

When the molded article of each example or the like is produced, a state of the mixture obtained by mixing the components (the state before being fed into the LABO PLASTOMILL) was visually observed to evaluate the miscibility of the compositions used in the molded article of each example or the like. The evaluation criteria are as follows. The results are shown in Table 1 and Table 2.

### Evaluation Criteria

“A case where it is powdery with little stickiness and has good fluidity”

. . . “Excellent”

“A case where it is powdery with some stickiness and has some flowability”

. . . “Fair”p “A case where it is chunky with high stickiness and has poor flowability”

. . . “Fail”

### Moldability

The moldability was determined by whether or not the molded article is easily detached from the mold during molding of the molded article of each example or the like described above. In a case where the molded article was easily detached from the mold, “moldability was determined to be good”; whereas in a case where the molded article was not easily detached from the mold, the moldability was determined to be “poor”. The results are shown in Table 1 and Table 2. Note that in Tables 1 and 2, “good moldability” is evaluated as “Excellent”, and the “poor moldability” is evaluated as “Fail”.

### Compression Set (Resilience)

A compression set of the molded article (60 mm×60 mm×12 mm) of each example or the like was evaluated simply by squeezing and deforming the molded article with a finger to check the return of shape deformation visually for a period of time. The results are shown in Table 1 and Table 2. Note that in a case where the shape was restored within 10 minutes after being squeezed by a finger, the result of the compression set was evaluated as “Excellent”; whereas in a case where the shape was not restored within 10 minutes, the result of the compression set was evaluated as “Fail”.

### Filler Bloom

The appearance of the filler was visually checked on the surface of the molded article of each example or the like. The results are shown in Table 1 and Table 2. Note that in Tables 1 and 2, a case where the filler did not appear on the surface of the molded article was evaluated as “Excellent”, and a case where the filler appeared on the surface of the molded article was evaluated as

“Fail”.

### Flame Retardancy

The flame retardancy was evaluated in the same manner as in UL94 Vertical Burn test for the molded article of each example or the like (125 mm×13 mm×1 mm). The results are shown in Table 1 and Table 2.

### Oil Bleeding

A test piece was cut from a molded article of each example into a size of 10 mm×10 mm×6 mm. The test piece was placed in a constant-temperature bath at 60° C. and left for 24 hours with the test piece resting on drug-wrapping paper. Thereafter, the drug-wrapping paper on which the test piece was placed was removed from the inside of the constant-temperature bath, and the oil bleeding into the drug-wrapping paper was visually checked.

### Evaluation Criteria

A case where there was no or little oil bleeding from the test piece to the drug-wrapping paper

. . . “Excellent”

A case where oil bleeding was seen from the entire test piece to the drug-wrapping paper

. . . “Fail”

TABLE 1

| | Examples | | | |
|---|---|---|---|---|
| | 1 | 2 | 3 | 4 |
| Styrene-based | 100 | 100 | 100 | 100 |
| elastomer | | | | |
| Process oil | 510.0 | 510.0 | 510.0 | 510.0 |
| Release agent | 37.7 | 37.7 | 37.7 | 37.7 |
| Metal deactivator | 5.66 | 5.66 | 5.66 | 5.66 |
| Antioxidant | 5.66 | 5.66 | 5.66 | 5.66 |
| Aluminum hydroxide | 1150.0 | 1046.0 | 959.0 | 920.0 |
| (10 μm) | | | | |
| Surface-treated | 0 | 104.0 | 191.0 | 230.0 |
| aluminum hydroxide | | | | |
| (10 μm) | | | | |
| Expanded graphite | 77.3 | 77.3 | 77.3 | 77.3 |
| (10 μm) | | | | |
| Hardness (Asker C) | 25 | 24.5 | 22 | 22 |
| Thermal | 1.05 | 1.04 | 1.01 | 0.99 |
| conductivity (W/m · K) | | | | |
| Volume resistivity | 1 × 10¹⁴ | 1 × 10¹⁴ | 1 × 10¹⁴ | 1 × 10¹⁴ |
| (Ω · cm) | | | | |
| Withstand voltage (kV) | 8.41 | 7.31 | 6.18 | 8.41 |
| Specific gravity | 1.47 | 1.48 | 1.49 | 1.47 |
| Miscibility | Excellent | Excellent | Excellent | Excellent |
| Moldability | Excellent | Excellent | Excellent | Excellent |
| Compression Set | Excellent | Excellent | Excellent | Excellent |
| Filler Bloom | Excellent | Excellent | Excellent | Excellent |
| Flame retardancy | V-2 | V-2 | V-2 | V-2 |
| Oil bleeding | Excellent | Excellent | Excellent | Excellent |
| | Examples | | | |
| | 5 | 6 | 7 | 8 |
| Styrene-based | 100 | 100 | 100 | 100 |
| elastomer | | | | |
| Process oil | 510.0 | 510.0 | 410.0 | 530.0 |
| Release agent | 37.7 | 37.7 | 37.7 | 37.7 |
| Metal deactivator | 5.66 | 5.66 | 5.66 | 5.66 |
| Antioxidant | 5.66 | 5.66 | 5.66 | 5.66 |
| Aluminum hydroxide | 863.0 | 767.0 | 959.0 | 959.0 |
| (10 μm) | | | | |
| Surface-treated | 287.0 | 383.0 | 191.0 | 191.0 |
| aluminum hydroxide | | | | |
| (10 μm) | | | | |
| Expanded graphite | 77.3 | 77.3 | 77.3 | 77.3 |
| (10 μm) | | | | |
| Hardness (Asker C) | 21 | 19 | 31 | 18 |
| Thermal | 0.98 | 0.96 | 1.04 | 0.99 |
| conductivity (W/m · K) | | | | |
| Volume resistivity | 1 × 10¹⁴ | 1 × 10¹⁴ | 1 × 10¹⁴ | 1 × 10¹⁴ |
| (Ω · cm) | | | | |
| Withstand voltage (kV) | 11.8 | 11.8 | 6.01 | 7.66 |
| Specific gravity | 1.45 | 1.47 | 1.66 | 1.42 |
| Miscibility | Good | Fail | Excellent | Fail |
| Moldability | Excellent | Excellent | Excellent | Excellent |
| Compression Set | Excellent | Excellent | Excellent | Excellent |
| Filler Bloom | Excellent | Excellent | Excellent | Excellent |
| Flame retardancy | V-2 | V-2 | V-2 | V-2 |
| Oil bleeding | Excellent | Excellent | Excellent | Excellent |

TABLE 2

| | Comparative Example | | | |
|---|---|---|---|---|
| | 1 | 2 | 3 | 4 |
| Styrene-based | 100 | 100 | 100 | 100 |
| elastomer | | | | |
| Process oil | 510.0 | 510.0 | 510.0 | 510.0 |
| Release agent | 37.7 | 37.7 | 37.7 | 37.7 |
| Metal deactivator | 5.66 | 5.66 | 5.66 | 5.66 |
| Antioxidant | 5.66 | 5.66 | 5.66 | 5.66 |
| Aluminum hydroxide | | | | |
| (1 μm) | | | | |
| Aluminum hydroxide | 1150.0 | 1150.0 | 1150.0 | 1150.0 |
| (10 μm) | | | | |
| Aluminum hydroxide | | | | |
| (27 μm) | | | | |
| Aluminum hydroxide | | | | |
| (80 μm) | | | | |
| Aluminumhydroxide | | | | |
| (105 μm) | | | | |
| Artificial graphite | 77.3 | | | |
| (10 μm) | | | | |
| Expanded graphite | | | | |
| (10 μm) | | | | |
| Expanded graphite | | 77.3 | | |
| (75 μm) | | | | |
| Expanded graphite | | | 77.3 | |
| (250 μm) | | | | |
| Expandable graphite | | | | 77.3 |
| (180 μm) | | | | |
| Hardness (Asker C) | 23.5 | 25 | 38 | 23 |
| Thermal | 0.87 | 1.10 | 2.20 | 0.95 |
| conductivity (W/m · K) | | | | |
| Volume resistivity | 1 × 10¹⁴ | 1 × 10¹⁴ | 1 × 10¹² | 1 × 10¹⁴ |
| (Ω · cm) | | | | |
| Withstand voltage (kV) | 10.7 | 5.60 | 4.20 | 10.7 |
| Specific gravity | 1.50 | 1.47 | 1.45 | 1.41 |
| Miscibility | Excellent | Excellent | Excellent | Excellent |
| Moldability | Excellent | Excellent | Excellent | Excellent |
| Compression Set | Excellent | Excellent | Excellent | Excellent |
| Filler Bloom | Excellent | Excellent | Excellent | Excellent |
| Flame retardancy | V-2 | V-2 | V-2 | V-2 |
| Oil bleeding | Excellent | Excellent | Excellent | Excellent |
| | Comparative Example | | | |
| | 5 | 6 | 7 | 8 |
| Styrene-based | 100 | 100 | 100 | 100 |
| elastomer | | | | |
| Process oil | 510.0 | 510.0 | 510.0 | 510.0 |
| Release agent | 37.7 | 37.7 | 37.7 | 37.7 |
| Metal deactivator | 5.66 | 5.66 | 5.66 | 5.66 |
| Antioxidant | 5.66 | 5.66 | 5.66 | 5.66 |
| Aluminum hydroxide | 1150.0 | | | |
| (1 μm) | | | | |
| Aluminum hydroxide | | | | |
| (10 μm) | | | | |
| Aluminum hydroxide | | 1150.0 | | |
| (27 μm) | | | | |
| Aluminum hydroxide | | | 1150.0 | |
| (80 μm) | | | | |
| Aluminum hydroxide | | | | 1150.0 |
| (105 μm) | | | | |
| Artificial graphite | | | | |
| (10 μm) | | | | |
| Expanded graphite | 77.3 | 77.3 | 77.3 | 77.3 |
| (10 μm) | | | | |
| Expanded graphite | | | | |
| (75 μm) | | | | |
| Expanded graphite | | | | |
| (250 μm) | | | | |
| Expandable graphite | | | | |
| (180 μm) | | | | |
| Hardness (Asker C) | 31 | 21 | 20 | 21 |
| Thermal | 1.05 | 1.05 | 0.94 | 0.96 |
| conductivity (W/m · K) | | | | |
| Volume resistivity | 1 × 10¹⁴ | 1 × 10¹⁴ | 2 × 10¹³ | 5 × 10¹² |
| (Ω · cm) | | | | |
| Withstand voltage (kV) | 8.41 | 8.41 | 2.22 | 1.62 |
| Specific gravity | 1.45 | 1.48 | 1.49 | 1.50 |
| Miscibility | Fail | Excellent | Excellent | Excellent |
| Moldability | Excellent | Excellent | Excellent | Excellent |
| Compression Set | Fail | Excellent | Excellent | Excellent |
| Filler Bloom | Excellent | Fail | Fail | Fail |
| Flame retardancy | V-2 | V-2 | V-2 | V-2 |
| Oil bleeding | Excellent | Excellent | Fail | Fail |

As indicated in Table 1, the molded articles of Examples 1 to 8 had excellent thermal conductivity, insulating properties, low hardness, and moldability, and suppressed the occurrence of oil bleeding.

As indicated in Table 2, the molded article of Comparative Example 1 contains artificial graphite (average particle diameter: 10 μm) together with aluminum hydroxide (average particle diameter: 10 μm) as the thermally conductive filler. The molded article of Comparative Example 1 had a low thermal conductivity (W/m⋅K). As described above, the reason why the thermal conductivity of the sheet-shaped molded article in the thickness direction is low is presumed that the shape of the artificial graphite used is flat, and such artificial graphite is disposed along the surface direction of the sheet in the molded article.

The molded article of Comparative Example 2 contains expanded graphite having a large average particle diameter (average particle diameter of: 75 μm) together with aluminum hydroxide (average particle diameter: 10 μm) as the thermally conductive filler. The molded article of Comparative Example 2 resulted in a low withstand voltage (kV).

The molded article of Comparative Example 3 contains expanded graphite having a large average particle diameter (average particle diameter of: 250 μm) together with aluminum hydroxide (average particle diameter: 10 μm) as the thermally conductive filler. In the molded article of Comparative Example 3, the hardness (Asker C) was excessively high, and both the volume resistivity (Ω⋅cm) and the withstand voltage (kV) were low.

The molded article of Comparative Example 4 contains expandable graphite having a large average particle diameter (average particle diameter of: 180 μm) together with aluminum hydroxide (average particle diameter: 10 μm) as the thermally conductive filler. The molded article of Comparative Example 4 had a low thermal conductivity (W/m⋅K).

The molded article of Comparative Example 5 contains expanded graphite (average particle diameter of: 10 μm) together with aluminum hydroxide having a small average particle diameter (average particle diameter: 1 μm). Since the shape of the molded article of Comparative Example 5 was not restored within 10 minutes after being squeezed by a finger, the results of the compression set were poor, and there was a problem in resilience.

The molded article of Comparative Example 6 contains expanded graphite (average particle diameter of: 10 μm) together with aluminum hydroxide having a large average particle diameter (average particle diameter: 27 μm). In the molded article of Comparative Example 6, the filler bloom was found on the surface.

The molded article of Comparative Example 7 contains expanded graphite (average particle diameter of: 10 μm) together with aluminum hydroxide having a large average particle diameter (average particle diameter: 80 μm). The molded article of Comparative Example 7 had a low thermal conductivity (W/m⋅K) and a low withstand voltage (kV). In addition, in the molded article of Comparative Example 7, the filler bloom was found on the surface, and the oil bleeding also occurred.

The molded article of Comparative Example 8 contains expanded graphite (average particle diameter of: 10 μm) together with aluminum hydroxide having an average large particle diameter (average particle diameter: 105 μm). In the molded article of Comparative Example 8, both the volume resistivity (Ω⋅cm) and the withstand voltage (kV) were low, and the filler bloom on the surface and the oil bleeding were found.

The present technology is not limited to the embodiments described above, and various changes and modifications can be made without departing from the spirit and scope of the present technology. Accordingly, the following claims are appended to disclose the scope of the present technology.

1. A thermally conductive elastomer composition comprising a blend of:
100 parts by mass of a styrene-based elastomer;
from 400 to 540 parts by mass of a process oil formed of a petroleum-based hydrocarbon;
from 950 to 1350 parts by mass of aluminum hydroxide having an average particle diameter from 3 μm to 20 μm; and
from 70 to 80 parts by mass of expanded graphite having an average particle diameter from 3 μm to 20 μm,
wherein a difference between the average particle diameter of the aluminum hydroxide and the average particle diameter of the expanded graphite is within 5 μm.

2. The thermally conductive elastomer composition according to claim 1, wherein:
the aluminum hydroxide is a surface-treated aluminum hydroxide that has undergone a surface treatment, and
an amount of the surface-treated aluminum hydroxide is 400 parts by mass or less.

3. The thermally conductive elastomer composition according to claim 1, wherein an amount of the process oil is from 430 to 530 parts by mass.

4. The thermally conductive elastomer composition according to claim 1, wherein the expanded graphite is in a state of flakes of graphite and granules and/or chunks of graphite being mixed.

5. A thermally conductive molded article obtained by molding the thermally conductive elastomer composition described in claim 1.

6. The thermally conductive elastomer composition according to claim 2, wherein an amount of the process oil is from 430 to 530 parts by mass.

7. The thermally conductive elastomer composition according to claim 6, wherein the expanded graphite is in a state of flakes of graphite and granules and/or chunks of graphite being mixed.

8. A thermally conductive molded article obtained by molding the thermally conductive elastomer composition described in claim 7.

9. A thermally conductive molded article obtained by molding the thermally conductive elastomer composition described in claim 6.

10. The thermally conductive elastomer composition according to claim 2, wherein the expanded graphite is in a state of flakes of graphite and granules and/or chunks of graphite being mixed.

11. A thermally conductive molded article obtained by molding the thermally conductive elastomer composition described in claim 10.

12. The thermally conductive elastomer composition according to claim 3, wherein the expanded graphite is in a state of flakes of graphite and granules and/or chunks of graphite being mixed.

13. A thermally conductive molded article obtained by molding the thermally conductive elastomer composition described in claim 12.

14. A thermally conductive molded article obtained by molding the thermally conductive elastomer composition described in claim 2.

15. A thermally conductive molded article obtained by molding the thermally conductive elastomer composition described in claim 3.

16. A thermally conductive molded article obtained by molding the thermally conductive elastomer composition described in claim 4.
